(19) United States
(12) Patent Application Publication
(10) Pub. No.: US 2026/0219625 A1
(43) Pub. Date: Jul. 30, 2026

(54) SHEET FEEDING APPARATUS AND IMAGE FORMING APPARATUS INCLUDING SHEET FEEDING APPARATUS

(71) Applicant: CANON KABUSHIKI KAISHA, Tokyo (JP)

(72) Inventors: HIROSHI SAITO, Ibaraki (JP); SHO OTA, Chiba (JP)

(21) Appl. No.: 19/428,993

(22) Filed: Dec. 22, 2025

(30) Foreign Application Priority Data
Jan. 30, 2025 (JP) 2025-013571

(51) Int. Cl. G03G 15/00

(52) U.S. Cl. CPC G03G 15/6511; G03G 15/6529; G03G 2215/00396; G03G 2215/004; G03G 2215/00476; G03G 2215/00616; G03G 2215/00721; G03G 2215/00742

(57) ABSTRACT

A sheet feeding apparatus includes a sheet supporting portion, a lifting unit, an air blowing unit, a sheet feeding belt, a detection unit, and a control unit. When a sheet is a double-sided processed sheet with both surfaces coated, the control unit stops the sheet supporting portion at a position at which a distance between the position of the uppermost sheet detected by the detection unit and the sheet feeding belt corresponds to a first distance, and when a sheet is a single-sided processed sheet with a first surface of the sheet coated and a second surface opposite to the first surface not coated, the control unit stops the sheet supporting portion at a position at which the distance between the position of the uppermost sheet detected by the detection unit and the sheet feeding belt corresponds to a second distance that is shorter than the first distance.

### BACKGROUND

### Field of the Technology

This disclosure relates to a sheet feeding apparatus and to an image forming apparatus including the sheet feeding apparatus.

### Description of the Related Art

Image forming apparatuses such as printers and copiers include sheet feeding apparatuses that feed sheets to image forming units that form images. Hitherto, a sheet feeding apparatus of an air feeding method is proposed in which air is blown onto sheets stacked on a vertically movable loading plate for floating the sheets and the sheets are fed by being attracted onto a rotating belt one sheet at a time (Japanese Patent Laid-Open No. 2024-169261).

In recent years, sheets having surfaces coated with coating agents are utilized to obtain deliverables that form images of higher resolution and elevated image quality. Such sheets (referred to as coated paper) are broadly classified into single-sided coated paper, which is coated on only one side, and double-sided coated paper, which is coated on both sides.

In a case of the double-sided coated paper, there is a risk of separation failure in which a plurality of sheets may be simultaneously separated from the loading plate by air and are subjected to double feeding, and, in a case of the single-sided coated paper, there is a risk of attracting failure in which the sheet is not floated from the loading plate by air and is not separated. This is because, in the case of the double-sided coated paper, both coated surfaces exhibit a high degree of smoothness and the sheets loaded on the loading plate tend to adhere to each other, and, in the case of the single-sided coated paper, curling is likely to occur due to differences in surface properties between the coated and uncoated surfaces. Hitherto, it is difficult to simultaneously achieve both the suppression of the separation failure, which may occur in the case of the double-sided coated paper, and the prevention of the attracting failure, which may occur in the case of the single-sided coated paper.

### SUMMARY

This disclosure provides a sheet feeding apparatus that can suppress the occurrence of separation failure and attracting failure of a sheet when feeding a surface-coated sheet from a loading plate, and an image forming apparatus including such a sheet feeding apparatus.

According to a first aspect of the present disclosure, a sheet feeding apparatus includes a sheet supporting portion configured to support a sheet, a lifting unit configured to vertically move the sheet supporting portion, an air blowing unit configured to float the sheet by blowing air to the sheet supported on the sheet supporting portion, a sheet feeding belt configured to convey the sheet by attracting the sheet which is floated, a detection unit configured to detect a position of an uppermost sheet supported on the sheet supporting portion, and a control unit configured to control the lifting unit. In a case where a sheet supported on the sheet supporting portion is a double-sided processed sheet with both surfaces coated with a coating agent, the control unit is configured to stop the sheet supporting portion at a position at which a distance between the position of the uppermost sheet detected by the detection unit and the sheet feeding belt corresponds to a first distance, and in a case where a sheet supported on the sheet supporting portion is a single-sided processed sheet with a first surface of the sheet coated with the coating agent and a second surface opposite to the first surface not coated with the coating agent, the control unit is configured to stop the sheet supporting portion at a position at which the distance between the position of the uppermost sheet detected by the detection unit and the sheet feeding belt corresponds to a second distance that is shorter than the first distance.

According to a second aspect of the present disclosure, an image forming apparatus includes the sheet feeding apparatus, and an image forming unit configured to form an image on the sheet that is fed from the sheet feeding apparatus.

According to a third aspect of the present disclosure, a sheet feeding apparatus includes a sheet supporting portion configured to support a sheet, a lifting unit configured to vertically move the sheet supporting portion, an air blowing unit configured to float the sheet by blowing air to the sheet supported on the sheet supporting portion, a detection unit configured to detect a position of an uppermost sheet supported on the sheet supporting portion, and a control unit configured to control the lifting unit. In a case where the sheet supported on the sheet supporting portion is a single-sided processed sheet with one surface coated with a coating agent, the control unit is configured to stop the sheet supporting portion at a higher position than a position at which the sheet supporting portion is stopped in a case where the sheet supported on the sheet supporting portion is a double-sided processed sheet with both surfaces coated with a coating agent.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming apparatus which is suitable for utilizing a sheet feeding apparatus according to this embodiment.

FIG. 2 is a perspective view illustrating a lifting mechanism of a loading plate.

FIG. 3 is a perspective view illustrating an upper surface detection unit.

FIG. 4A is a schematic diagram illustration a case when a distance between an uppermost sheet and an attracting belt is a first distance.

FIG. 4B is a schematic diagram illustration a case when the distance between the uppermost sheet and the attracting belt is a second distance.

FIG. 5 is a block diagram illustrating a control system of the lifting mechanism.

FIG. 6A is a schematic diagram illustration a case where a sheet does not exhibit a curl.

FIG. 6B is a schematic diagram illustration a case where the sheet exhibits a downward curl.

FIG. 7 is a flowchart illustrating a lifting control process of this embodiment.

FIG. 8 is a flowchart illustrating another embodiment of a lifting control process.

FIG. 9 is a schematic diagram illustrating an image forming apparatus to which an external sheet feeding apparatus is connected.

### DESCRIPTION OF THE EMBODIMENTS

### Image Forming Apparatus

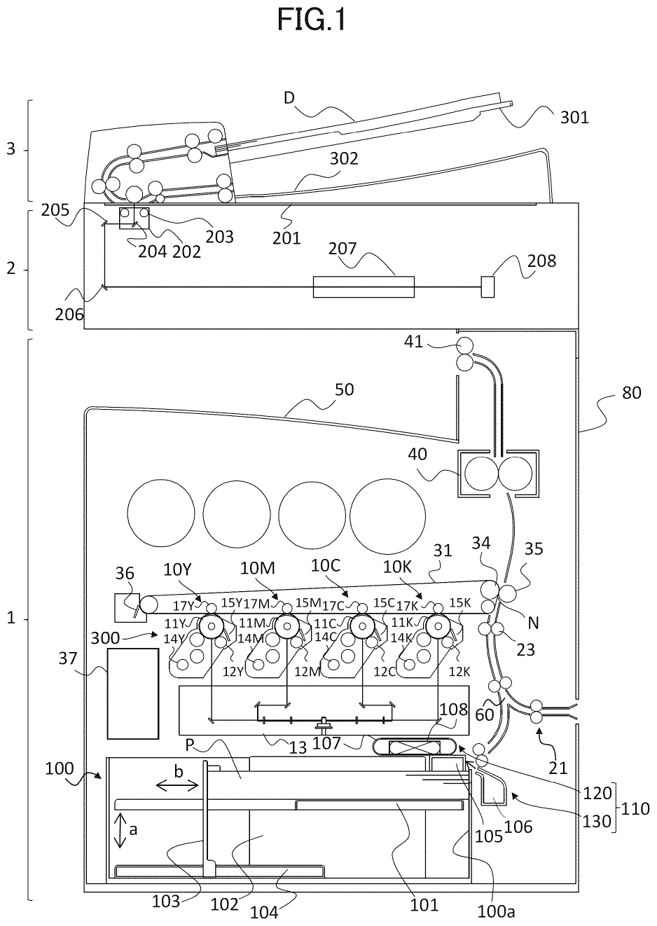

Hereinafter, with reference to drawings, an embodiment of this disclosure will be described. First, using FIG. 1, an image forming apparatus which is suitable for utilizing a sheet feeding apparatus of this embodiment will be described. The image forming apparatus 1 illustrated in FIG. 1 serves as an example of a digital color copier, and, here, an image reading unit 2 and a document conveyance unit 3 are disposed on top of an apparatus body 80 of the image forming apparatus 1.

The document conveyance unit 3 feeds documents D, which are set face-up on a document tray 301, one sheet at a time in sequence from the first page, conveys the documents via a document conveyance path to pass over a platen glass 201 disposed in the image reading unit 2, and thereafter discharges the documents to a document discharge tray 302.

When the document D conveyed by the document conveyance unit 3 passes over the platen glass 201 from a left side to a right side in FIG. 1, the image reading unit 2 performs an image reading process by a scanner unit 202 held at a predetermined position. In particular, a reading surface of the document D is illuminated by light from a lamp 203 disposed in the scanner unit 202, and reflected light from the document D is guided to a lens 207 through mirrors 204, 205, and 206. The light passed through the lens 207 is focused onto an imaging plane of an image sensor 208, and, thereby, a signal that is output from the image sensor 208 is converted into an electrical digital signal and is transmitted to a main control unit, not shown.

To be noted, the image reading unit 2 can perform the image reading process without using the document conveyance unit 3. In such a case, a user directly sets the document D on the platen glass 201 which is opened by pivoting the document conveyance unit 3 upward, and then lowers the document conveyance unit 3 downward to return the document conveyance unit 3 to its original position. Thereafter, the image reading unit 2 performs the image reading process of the document D, which the user has set on the platen glass 201, by the scanner unit 202 which scans from left to right. In addition, the document conveyance unit 3 need not be disposed, and, in such a case, a document pressing portion that presses the document D set on the platen glass 201 from above is disposed in a manner capable of pivoting with respect to the image reading unit 2 in a vertical direction.

The image forming apparatus 1 illustrated in FIG. 1 includes image forming stations 10Y, 10M, 10C, and 10K for forming toner images of four colors: yellow (Y), magenta (M), cyan (C), and black (Bk). Since each of the image forming stations 10Y to 10K is basically the same except for the color of toner, hereinafter, the image forming station 10Y will be described as a representative.

An electrostatic latent image is formed on a photosensitive drum 11 such that, after being uniformly charged by a charge roller 12Y, a surface of the photosensitive drum 11Y is irradiated with a laser beam from a laser scanner 13, which is driven based on a transmitted image information signal. The electrostatic latent image formed on the photosensitive drum 11Y is developed into the toner image by a developing unit 14Y. The developing unit 14Y develops the electrostatic latent image into the toner image using developer containing the toner and a carrier. A primary transfer voltage is applied to the toner image formed on the photosensitive drum 11Y by a primary transfer roller 17Y disposed to face the photosensitive drum 11Y across an intermediate transfer belt 31, and, thereby, the toner image is primarily transferred from the photosensitive drum 11Y onto the intermediate transfer belt 31. Primary transfer residual toner remaining on the photosensitive drum 11Y after the primary transfer is removed from the photosensitive drum 11Y by a photosensitive drum cleaner 15Y, and is collected to a waste toner container 37.

A sheet feeding deck 100, serving as an example of the sheet feeding apparatus, is disposed in the image forming apparatus 1. In this embodiment, the sheet feeding deck 100 is disposed in an interior of the apparatus body 80 of the image forming apparatus 1. The sheet feeding deck 100 includes a loading plate 101, a pair of side regulating plates 102, a trailing edge regulating plate 103, a guide rail 104, and a sheet storage portion 100a. A sheet P is supported in a loadable manner on the loading plate 101, which serves as an example of a sheet supporting portion. To be noted, whether or not the sheet P is stacked on the loading plate 101 is detected by a sheet detection sensor, not shown.

The pair of side regulating plates 102 are arranged to face each other across the sheet P stacked on the loading plate 101 in a width direction intersecting a feeding direction of the sheep P, and disposed such that the user can move the side regulating plates in accordance with a sheet width of the sheet P stacked on the loading plate 101. In conjunction with the movement of the side regulating plate 102 on one side by the user, the side regulating plate 102 on the other side moves in an interlocking manner in the opposite direction. The trailing edge regulating plate 103 is disposed to be movable along the guide rail 104 in the feeding direction (arrow b direction), and the user can move the trailing edge regulating plate 103 in accordance with the size of the sheet P stacked on the loading plate 101.

The sheet P is sandwiched by the pair of side regulating plates 102 with respect to the width direction intersecting the feeding direction of the sheet P, and is sandwiched by a wall surface of the sheet storage portion 100a and the trailing edge regulating plate 103 with respect to the feeding direction of the sheet P. In this manner, the sheet P is stacked on the loading plate 101 in a state of being positioned within the sheet storage portion 100a.

On the loading plate 101, it is possible to stack double-sided coated paper (double-sided processed sheet) having both surfaces coated with a coating agent, single sided coated paper (single-sided processed sheet) having one surface coated with a coating agent, plain paper having surfaces not coated with any coating agent, and the like. The single-sided coated paper is, for example, a sheet in which a first surface is coated with a coating agent and a second surface opposite to the first surface is not coated with a coating agent. In the case of this embodiment, to form the image on a coated surface (image forming surface) which has been coated, the single-sided coated paper is stacked on the loading plate 101 with the coated surface directed upward.

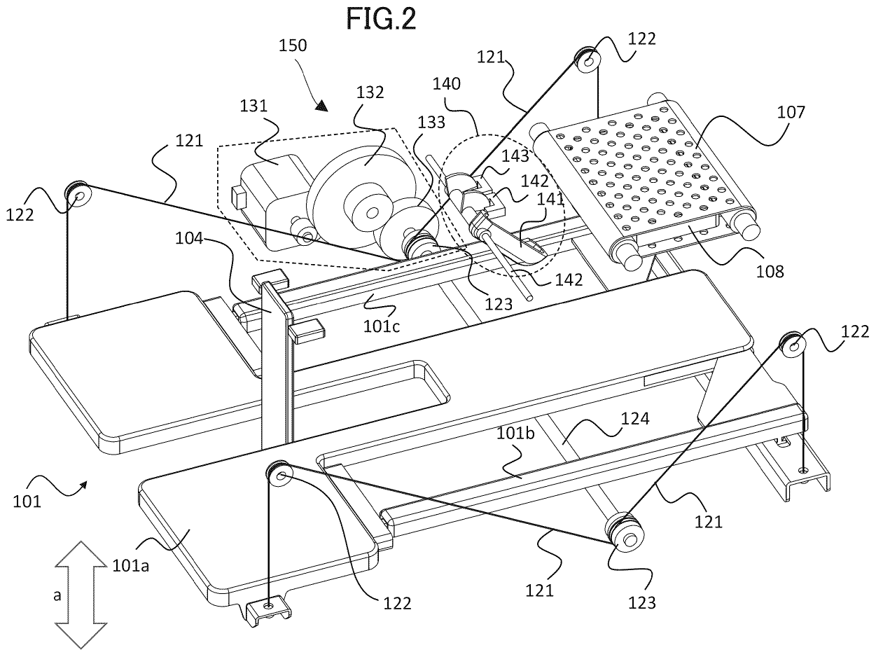

The sheet storage portion 100a is disposed such that the user can withdraw the sheet storage portion 100a from the apparatus body 80 in the width direction along slide rails, not shown. For enabling the withdrawal of the sheet storage portion 100a, the apparatus body 80 is provided with an opening/closing door (not shown) that can be opened and closed by the user. An opening/closing state of the opening/closing door is detected by an opening/closing sensor, not shown. In a case where the opening/closing door is opened by the user and then the sheet storage portion 100a is withdrawn from the apparatus body 80, the loading plate 101 is lowered to a lower limit position to facilitate the user in performing the replenishment, replacement, and the like of the sheet P. In a case where the sheet storage portion 100a is returned to the apparatus body 80 and the opening/closing door is closed, the loading plate 101 is elevated from the lower limit position. The loading plate 101 is disposed within the sheet storage portion 100a so as to be vertically movable in a vertical direction (arrow a direction) by a lifting mechanism 150 described below (refer to FIG. 2).

The sheet P is accommodated in a stacked configuration within the sheet storage portion 100a, and is sequentially fed to a conveyance path 60 from an uppermost sheet P among the stacked sheets by a sheet feeding unit 110, described below, in synchronization with the timing of image formation. The sheet P fed from the sheet storage portion 100a to the conveyance path 60 is conveyed to a registration roller pair 23 arranged at an intermediate position within the conveyance path 60. The registration roller pair 23 corrects the skew of the sheet P. In particular, a leading edge of the sheet P abuts against a nip portion of the registration roller pair 23 which is in a stopped state, and the sheet P forms a loop, so that the skew correction is performed. Thereafter, the registration roller pair 23 rotates in synchronization with the timing of the transfer of the toner image formed on the intermediate transfer belt 31, and conveys the sheet P to a secondary transfer portion N.

The secondary transfer portion N is a nip portion formed by a secondary transfer inner roller 34 and a secondary transfer outer roller 35, which are disposed in opposition to each other across the intermediate transfer belt 31, and, by applying predetermined pressure and a secondary transfer voltage, the secondary transfer portion N secondarily transfers the toner image from the intermediate transfer belt 31 onto the sheet P. Secondary transfer residual toner remaining on the intermediate transfer belt 31 after the secondary transfer is removed from the intermediate transfer belt 31 by a belt cleaner 36, and collected in the waste toner container 37. To be noted, in the case of this embodiment, an image forming unit 300, which forms the toner image on the sheet P, is constituted by the image forming stations 10Y to 10K, the intermediate transfer belt 31, a plurality of tension rollers including the secondary transfer inner roller 34, the secondary transfer outer roller 35, and the like.

The sheet Ponto which the toner image has been transferred is conveyed to a fixing unit 40 through the conveyance path 60, and the toner image is fixed on the sheet P by applying heat and pressure in the fixing unit 40. The sheet P on which the toner image has been fixed by the fixing unit 40 is conveyed further upward through the conveyance path 60, and is discharged to a sheet discharge tray 50 by a sheet discharge roller pair 41.

### Sheet Feeding Unit

In this embodiment, the sheet feeding deck 100 includes the sheet feeding unit 110 of an air sheet feeding method that separates and feeds the sheet P stored in the sheet storage potion 100a one sheet at a time. The sheet feeding unit 110 includes an attracting and conveying portion 120 for attracting and conveying the sheet P stacked on the loading plate 101, and an air blowing unit 130 for floating to sort a plurality of sheets P stacked on the loading plate 101 and for separating the sheet P into one sheet at a time.

### Air-Blowing Unit

The air blowing unit 130 includes a sorting fan (not shown), a sorting duct 105, and a separation duct 106. The sorting duct 105 blows air to a side edge portion of the sheet P on the loading plate 101 from the width direction intersecting the feeding direction of the sheet P by guiding the air generated by the sorting fan. The air flows between each individual sheet P upon which the air is blown, and thereby the side edge portion of the sheet P to which the sorting air is applied is floated and separated. The separation duct 106 guides air generated by a separation fan (not shown), and, with respect to the feeding direction of the sheet P, blows the air (referred to as separation air) from a downstream side to a downstream edge portion of the sheet P on the loading plate 101. By applying the separation air to the downstream edge portion of the sheet P, whose side edge portion has been separated by the sorting air, the separation of the sheet P across the entire downstream region is facilitated. In this manner, the separation of the sheet P stacked on the loading plate 101 is performed for each individual sheet.

To be noted, the separation of the sheet P described above may be achieved by disposing at least the sorting fan and the sorting duct 105, and effecting the separation by means of air-blowing utilizing these sorting fan and the sorting duct 105. The separation air serves as an auxiliary to the sorting air, and the separation fan and the separation duct 106 may be omitted. The separation air is used as an auxiliary measure to facilitate the separation of the sheet P in cases where the sheet P has large size and weight, or where high-temperature and high-humidity conditions exist and sheets tend to adhere to each other, and the like; thus, it is anticipated that the sorting air alone may be insufficient to achieve adequate separation of the sheet P. FIG. 1 illustrates an example in which the air blowing unit 130 is provided with the separation fan and the separation duct 106 so as to enable the feeding of the sheet P, such as thick paper, having a large grammage.

### Attracting and Conveying Portion

The attracting and conveying portion 120 includes an attracting belt 107 and an attracting fan 108, and is arranged above the sheet storage portion 100a. A plurality of through holes are formed in the attracting belt 107, serving as an example of a sheet feeding belt, and the sheet P is attracted to the attracting belt 107 by drawing air through the through holes by means of the attracting fan 108. Then, the attracting belt 107, while retaining the sheet P in an attracted state, is rotated at predetermined timing by a drive source such as a motor, not shown. As described above, the sheet P separated by the air blowing unit 130 is attracted to the attracting belt 107 by the drawing of the attracting fan 108, and, when the attracting belt 107 attracting the sheet P rotates, the sheet P is fed to the conveyance path 60.

### Lifting Mechanism

Next, using FIG. 2, the lifting mechanism 150, serving as an example of a lifting unit for vertically moving the loading plate 101 with respect to the sheet storage portion 100a, will be described. As illustrated in FIG. 2, the lifting mechanism 150 includes a motor 131, serving as a drive source for vertically moving the loading plate 101, a stepped gear 132, a lifting gear 133, a lifting shaft 124, wire winding pulleys 123, wires 121, and rollers 122. The stepped gear 132 is disposed so as to be capable of rotating forward and reverse in accordance with the rotation of the motor 131, and the lifting gear 133 is disposed so as to be capable of rotating in a direction opposite to the stepped gear 132 in response to the rotation of the stepped gear 132. The lifting gear 133 is secured to the lifting shaft 124 extending from a first end side to a second end side of the lifting mechanism 150 in the width direction. Therefore, a rotational driving force of the motor 131 is transmitted to the lifting gear 133 via the stepped gear 132, and, thereby, the lifting shaft 124 rotates forward and reverse.

The wire winding pulleys 123 are disposed on each of the first and second end sides of the lifting shaft 124 so as to be rotatable in response to the lifting shaft 124. These two wire winding pulleys 123 are simultaneously rotated forward and reverse by the lifting shaft 124, so that winding amounts of the two wires 121 wound around each of the wire winding pulleys 123 are adjusted. Both ends of the two wires 121 are respectively connected to four corners of the loading plate 101, and each wire is connected to the corners via the two rollers, which are disposed apart from each other in the feeding direction. In this embodiment, in a case where the lifting shaft 124 rotates in a clockwise direction, since the wire winding pulleys 123 also rotate in the clockwise direction, the winding amounts of the wires 121 decrease, and the loading plate 101 moves downward. On the other hand, in a case where the lifting shaft 124 rotates in a counterclockwise direction, since the wire winding pulleys 123 also rotate in the counterclockwise direction, the winding amounts of the wires 121 increase, and the loading plate 101 moves upward.

### Upper Surface Detection Unit

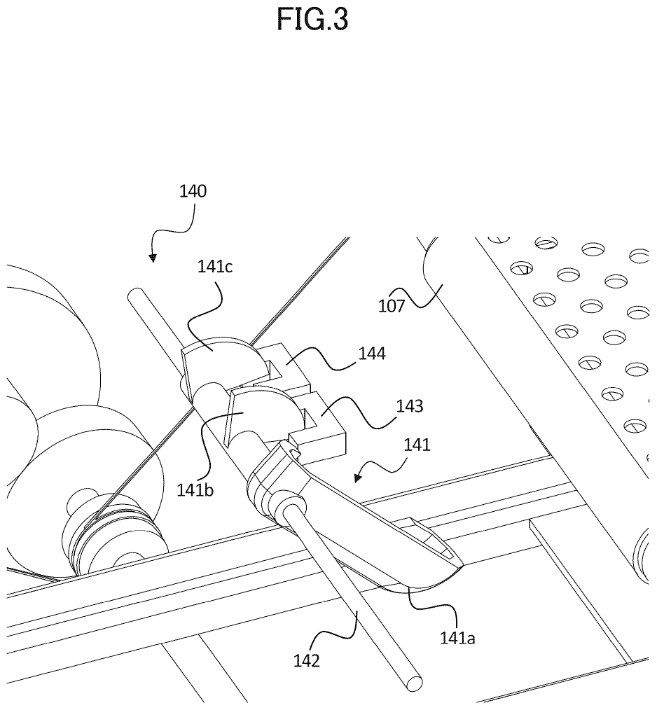

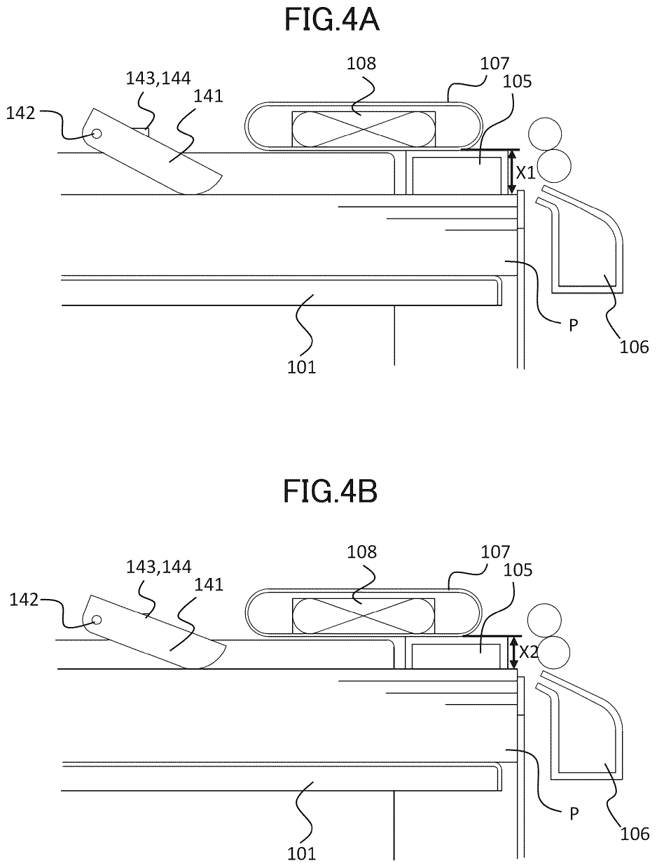

The sheet feeding deck 100 includes an upper surface detection unit 140 so as to be capable of detecting a sheet position of an uppermost sheet P among the sheets P stacked on the loading plate 101 in response to the vertical movement of the loading plate 101 described above. The upper surface detection unit 140 is an example of a detection unit. With reference to FIG. 2, using FIGS. 3 to 4B, the upper surface detection unit 140 will be described.

As illustrated in FIG. 3, the upper surface detection unit 140 includes a flag 141, serving as an example of a swing member, a sensor shielding portions 141b, serving as a first detected portion, being displaced in response to a swing of the flag 141, a sensor shielding portions 141c, serving as a second detected portion, being displaced independently of the sensor shielding portion 141b in response to the swing of the flag 141, a first optical sensor 143, serving as a first sensor, detecting the sensor shielding portion 141b that is displaced in response to the swing of the flag 141, a second optical sensor 144, serving as a second sensor detecting the sensor shielding portions 141c that is displaced in response to the swing of the flag 141. While omitted from the illustrations, the optical sensors 143 and 144 are photo interrupters including a light emitting portion for emitting light and a light receiving portion for receiving the light emitted from the light emitting portion. The flag 141 is disposed on a non-rotating sensor shaft 142 so as to be capable of swinging and coming into contact with the uppermost sheet P stacked on the loading plate 101 in response to a raising of the loading plate 101. That is, in response to the vertical movement of the loading plate 101, the flag 141 swings with a distal end portion 141a coming into contact with the uppermost sheet P stacked on the loading plate 101.

To be noted, as illustrated in FIG. 2, with respect to the feeding direction of the sheet P, the attracting belt 107 is disposed further downstream than a center of the loading plate 101 such that an upstream edge overlaps the loading plate 101 when viewed from above. In contrast, with respect to the feeding direction, the flag 141 comes into contact with the uppermost sheet P stacked on the loading plate 101 further upstream than the upstream edge of the attracting belt 107. To be noted, the flag 141 may be brought into contact with a region near a center in the width direction of the sheet P so as to enable the detection of the position of the uppermost sheet regardless of the width of the sheet P.

Returning to FIG. 3, the sensor shielding portions 141b and 141c are disposed in a longitudinal direction (width direction) of the sensor shaft 142 so as to be displaceable around the sensor shaft 142 in response to the swing of the flag 141. The flag 141 and the sensor shielding portions 141b and 141c swing in the same direction. Then, the sensor shielding portions 141b and 141c are disposed on the sensor shaft 142 so as to be capable of respectively blocking optical paths between the light emitting and receiving portions of the optical sensors 143 and 144. The sensor shielding portions 141b and 141c are each formed to have different lengths along a circumference of the sensor shaft 142. Thereby, in response to the swing of the flag 141, combinations of a detection state, in which the sensor shielding portion 141b or 141c is detected, and a non-detection state, in which the sensor shielding portion 141b or 141c is not detected, are established for each of the optical sensors 143 and 144.

In accordance with the combinations of the detection and non-detection states described above, this upper surface detection unit 140 can detect the sheet position (paper surface height) of the uppermost sheet P stacked on the loading plate 101 at two different positions. In this embodiment, it is possible to detect a sheet position at which a distance between the uppermost sheet P (in particular, upper surface) and the attracting belt 107 (in particular, lower surface) corresponds to a first distance, and a sheet position at which the distance between the uppermost sheet P (in particular, upper surface) and the attracting belt 107 (in particular, lower surface) corresponds to a second distance, which is shorter than the first distance. In the case of this embodiment, in a case where the optical sensors 143 and 144 have transitioned from a state in which both of the optical sensors 143 and 144 were in the detection state (initial state) to a state in which the optical sensors 143 on one side has transitioned to the non-detection state due to the elevation of the loading plate 101, it is detected that the sheet position corresponds to the first distance. In a case where the loading plate 101 has been further elevated and the optical sensors 143 and 144 have transitioned from a state in which the optical sensor 143 was in the non-detection state to a state in which both of the optical sensors 143 and 144 have transitioned to the non-detection state, it is detected that the sheet position corresponds to the second distance. Here, a first detection state is a state in which the first optical sensor 143 detects the sensor shielding portion 141b and the second optical sensor 144 detects the sensor shielding portion 141c. A second detection state is a state in which the first optical sensor 143 detects the sensor shielding portion 141b and the second optical sensor 144 does not detect the sensor shielding 141c or the first optical sensor 143 does not detect the sensor shielding portion 141b and the second optical sensor 144 detects the sensor shielding portion 141c. A non-detection state is a state in which the first optical sensor 143 does not detect the sensor shielding 141b and the second optical sensor 144 does not detect the sensor shielding 141c. That is, the upper surface detection unit 140 detects the position of the uppermost sheet based on whether the upper surface detection unit 140 is in the first detection state, the second detection state, or the non-detection state.

FIG. 4A illustrates the case where the distance between the uppermost sheet P and the attracting belt 107 corresponds to the “first distance”, and FIG. 4B illustrates the case where the distance between the uppermost sheet P and the attracting belt 107 corresponds to the “second distance”. In this embodiment, as described in detail below, it is possible to stop the loading plate 101 at each of the positions at which the sheet position corresponds to the “first distance (X1)” and the “second distance (X2)”.

### Control Block

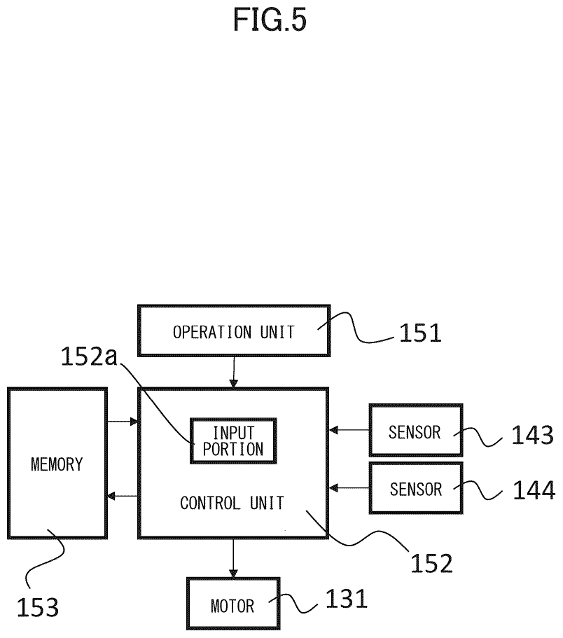

As described above, in this embodiment, the loading plate 101 is stopped at the positions at which the sheet position corresponds to the first and second distances described above. A control system of the lifting mechanism 150 for achieving this will be described using FIG. 5. In this embodiment, the sheet feeding deck 100 includes a control unit 152 for controlling the lifting mechanism 150.

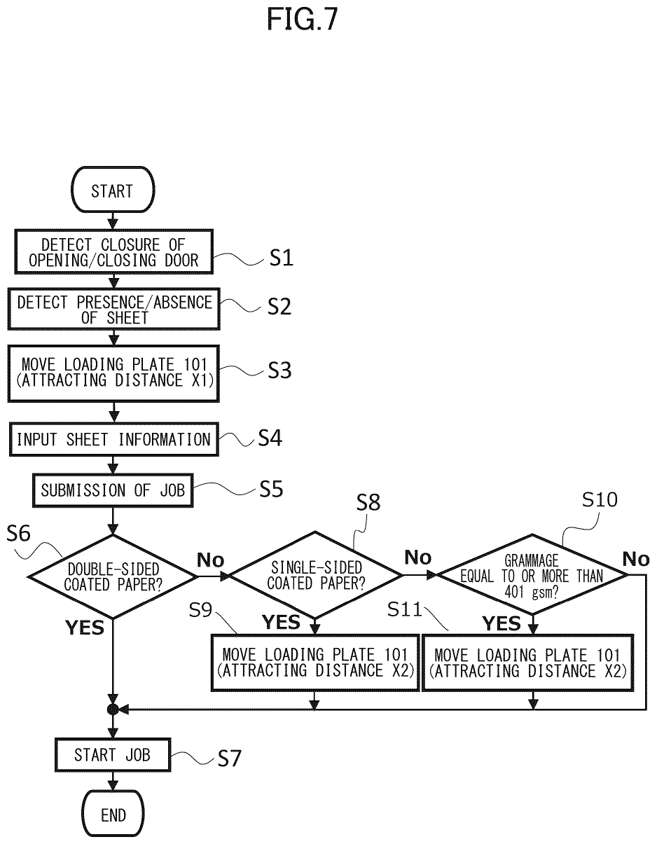

The control unit 152 includes, for example, a central processing unit (CPU), to which an operation unit 151, a memory 153, the optical sensors 143 and 144, the motor 131, and the like are connected. The memory 153 includes a read only memory (ROM), a random access memory (RAM), and the like, and various programs, such as a “lifting control process” described below (refer to FIG. 7), and various data, such as “attracting distance table data” (refer to Table 1), are stored in the ROM. The RAM temporarily stores arithmetic processing results and other data generated during the execution of various programs.

The operation unit 151 is, for example, a touch panel which the user can operate, and the user can set information related to the sheet P stacked on the loading plate 101 through touch operations on various screens displayed on the touch panel. The information related to the sheet P refers to, for example, information with respect to the sheet P stacked on the loading plate 101, such as whether a type of the sheet P falls under “single-sided coated paper, double-sided coated paper, or plain paper”, and whether the thickness (grammage) of the sheet P is categorized as “lightweight (equal to or less than 105 grams per square meter (gsm)), standard (106 to 300 gsm), heavyweight (301 to 400 gsm), or extra-heavyweight (equal to or more than 401 gsm)”, and the like. That is, the operation unit 151 serves as an example of an information input unit, and whether a type of the sheet P supported on the loading plate 101 corresponds to the single-sided coated paper or the double-sided coated paper can be input. The control unit 152 includes an input portion 152a that can obtain information related to the sheet P from the operation unit 151. To be noted, while, in this embodiment, the information related to the sheet P can be input through the operation unit 151, it is not limited to this. For example, using an external device such as a computer communicatively connected to the image forming apparatus 1 as the information input unit, it is acceptable to configure such that the information related to the sheet P can be input from the external device.

Based on the information related to the sheet P, by referencing the “attracting distance table data” stored in the ROM, the control unit 152 determines whether the attracting distance is to be set to the “first distance” or the “second distance”. Then, in accordance with the determined attracting distance, by controlling the motor 131, the control unit 152 vertically moves the loading plate 101 through the lifting mechanism 150 (refer to FIG. 2) such that the loading plate 101 is stopped at the position corresponding to the first distance or the position corresponding to the second distance. In response to this, the control unit 152 obtains the sheet position of the uppermost sheet P stacked on the loading plate 101 from the upper surface detection unit 140 described above.

Incidentally, as described above, since the double-sided coated paper tends to adhere to each other, there is a risk that separation failure may occur in which a plurality of sheets are simultaneously separated from the loading plate 101 and are subjected to double feeding. Therefore, it may be that, in a case of the double-sided coated paper, the sheet position (paper surface height) of the uppermost sheet P stacked on the loading plate 101 is brought to the lowest feasible level and the duration for which the sheet P is subjected to air blowing is increased. Thereby, the sheet P becomes more readily separated before being attracted onto the attracting belt 107. However, this may result in an increased likelihood of attracting failure in a case of the single-sided coated paper. Since, in the case of the single-sided coated paper, a downward curl in which the sheet curls toward a lower side tends to occur, when the sheet position (paper surface height) of the uppermost sheet P is lowered, the air blowing unit 130 cannot properly blow air onto the sheet P exhibiting the downward curl. Therefore, with respect to the sheet P exhibiting the downward curl, the sheet P cannot be floated from the loading plate 101 by air, and it is difficult to separate.

The reason why the downward curl tends to occur in the case of the single-sided coated paper will be described. The single-sided coated paper includes a coated surface on one side that has been coated with a coating agent, and an uncoated surface on the other side that has not been coated with a coating agent. While fluctuation in moisture content is reduced on the coated surface due to the coating agent, fluctuation in moisture content on the uncoated surface is substantial. Due to such a difference in the moisture content, uneven dimensional changes between the front and back surfaces of the sheet P occur, and the sheet P curls. Since the sheet P inherently contains moisture, it is particularly susceptible to curling in low humidity environments, and the uncoated side deforms concavely. In the case of this embodiment, as described above, since the single-sided coated paper is stacked on the loading plate 101 with the coated surface directed upward, sometimes the single-sided coated paper is stacked on the loading plate 101 in a state of exhibiting the downward curl (a state in which sheet edge portions are curved toward the lower side).

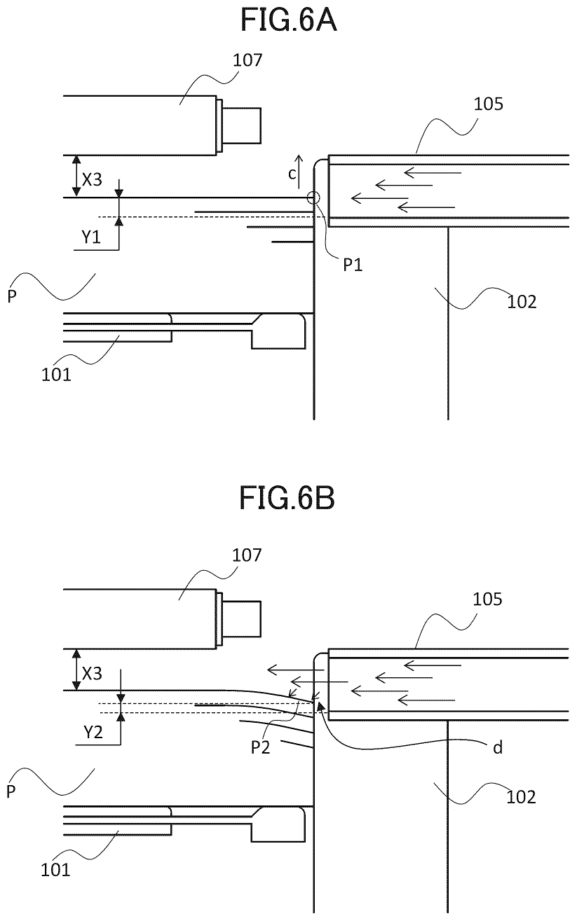

The reason why the sheet P exhibiting the downward curl is less likely to be floated by air in conventional configurations will be described using FIGS. 6A and 6B. FIG. 6A illustrates a case where the sheet is not curled, and FIG. 6B illustrates a case where the sheet exhibits the downward curl. In conventional configurations, the loading plate 101 is stopped such that the sheet position of the uppermost sheet P corresponds to an attracting distance “X3” regardless of the presence or absence of curling in the sheet P.

As described in FIG. 6A, the sorting air supplied from the sorting duct 105 impinges upon the side edge of the sheet P within a range indicated by Y1 with respect to the vertical direction, and the air infiltrates into small gaps existing between each sheet P, so that functions to widen the gaps between the sheets are exerted. Thereby, the sheet P adjacent to the sorting duct 105 is separated into one sheet at a time, and the sheet P is floated upward. In this manner, a side edge portion P1 of the uppermost sheet P is lifted upward (arrow c direction).

In contrast to this, there are primarily two reasons why the sheet P exhibiting the downward curl is difficult to float. The first reason is attributable to the inhibition of the float of the sheet P by the sorting air. As illustrated in FIG. 6B, when the sheet P exhibits the downward curl, air supplied from the sorting duct 105 advances along a curled sheet surface P2. At that time, a force pressing the sheet P in an arrow d direction is exerted on the sheet surface P2, and thereby the sheet P becomes less likely to float. The second reason is attributable to a reduced amount of air that infiltrates into the gaps between the sheets of the sheet P. When the sheet P exhibits the downward curl, since the range of the side edge of the sheet P impinged by air supplied from the sorting duct 105 is reduced (Y1→Y2), the number of sheets P that are lifted decreases, and an overall lifting force for lifting the sheet P is reduced.

### Lifting Control Process

In this embodiment, in view of the points described above, the sheet position is set lower for the case of the double-sided coated paper, i.e., the attracting distance is increased, and, on the other hand, the sheet position is set higher for the case of the single-sided coated paper, i.e., the attracting distance is reduced; thereby, both the suppression of the separation failure and the prevention of the attracting failure are achieved. Hereinafter, with reference to FIGS. 2 and 5, a “lifting control process” of this embodiment for achieving the above will be described using FIG. 7. FIG. 7 is a flowchart illustrating the “lifting control process” of this embodiment.

In a case where it is detected that the opening/closing door has been closed (STEP S1), the control unit 152 detects whether or not the sheet P is stacked on the loading plate 101 of the sheet storage portion 100a (STEP S2). Thereby, in a case where the sheet P is stacked by the user on the loading plate 101 of the sheet storage portion 100a, which was withdrawn from the apparatus body 80, it is possible to detect that the sheet storage portion 100a, on which the sheet P is stacked, has been returned to the apparatus body 80. In the case where the sheet storage portion 100a has been returned to the apparatus body 80 (STEP S2), the control unit 152 controls the motor 31 such that the loading plate 101 is elevated from the lower limit position and stopped by the lifting mechanism 150 (STEP S3). At this time, the control unit 152 elevates the loading plate 101 until the sheet position of the uppermost sheet P stacked on the loading plate 101 is positioned at an initial position. The initial position is a position at which it is possible to suppress both the separation failure and the attracting failure of the “double-sided coated paper”, and, in the case of this embodiment, the attracting distance corresponds to the “first distance (X1)” (e.g., 5 millimeters (mm)) indicated in the “attracting distance table data” (refer to Table 1).

Thereafter, the control unit 152 receives the input of the information related to the sheet P stacked on the loading plate 101 from the operation unit 151 (STEP S4). The information related to the sheet P is input before starting to feed the sheet P, that is, before starting an image formation job. Upon receiving the start of the image formation job (STEP S5), based on the input information related to the sheet P, the control unit 152 determines whether or not the sheet P stacked on the loading plate 101 is the “double-sided coated paper” (STEP S6).

In a case where the sheet P stacked on the loading plate 101 is the “double-sided coated paper” (STEP S6: YES), the control unit 152 starts the image formation job without moving the loading plate 101 (STEP S7). That is, the loading plate 101 is in a state of being stopped at a position at which the attracting distance corresponds to “5 mm (first distance)” (refer to STEP S3). When the sheet supported on the loading plate 101 is the “double-sided coated paper”, the control unit 152 is configured to keep the loading plate 101 stopped. Therefore, in the case of the double-sided coated paper, since the sorting air is blown to the uppermost sheet P at the sheet position at which the attracting distance corresponds to the “first distance (X1)”, the separation failure is suppressed. To be noted, since the double-sided coated paper is less likely to form curling, even if the sorting air is blown at the sheet position at which the attracting distance corresponds to the “first distance (X1)”, the attracting failure does not occur.

In a case where the sheet P stacked on the loading plate 101 is not the “double-sided coated paper” (STEP S6: NO) but the “single-sided coated paper” (STEP S8: YES), before starting the image formation job, the control unit 152 elevates and stops the loading plate 101 at a position at which the attracting distance corresponds to “3 mm (second distance)” (refer to Table 1) (STEP S9). Thereafter, the control unit 152 starts the image formation job (STEP S7). In the case of the single-sided coated paper, since the sorting air is blown to the sheet P at the sheet position at which the attracting distance corresponds to the “second distance (X2)”, which is shorter than the “first distance (X1)”, the attracting failure is suppressed. That is, even if the downward curl occurs in the sheet P, by elevating and stopping the loading plate 101 such that the uppermost sheet P approaches the attracting belt 107, it is possible to reduce the force, which is generated on the sheet surface P2 by the sorting air, for pressing the sheet P (refer to FIG. 6B), and it becomes easier to float the sheet P. In addition, even if the downward curl occurs in the sheet P, the range of the side edge of the sheets P onto which the sorting air is blown (refer to FIG. 6B) does not decrease, and the amount of the air infiltrating into the gaps between the sheets P is not reduced; therefore, an overall floating force for floating the sheet P is not reduced. Therefore, it is possible to suppress the attracting failure of the single-sided coated paper.

In a case where the sheet P stacked on the loading plate 101 is not the “single-sided coated paper”, that is, is the “plain paper (uncoated paper)” (STEP S8: NO), the control unit 152 determines whether or not a grammage of the sheet P is equal to or more than “401 gsm” (STEP S10). In a case where the grammage of the sheet P is equal to or more than “401 gsm” (STEP S10: YES), before starting the image formation job, the control unit 152 elevates and stops the loading plate 101 at a position at which the attracting distance corresponds to “3 mm (second distance)” (refer to Table 1) (STEP S11). Thereafter, the control unit 152 starts the image formation job (STEP S7). On the other hand, in a case where the grammage of the sheet P is less than “401 gsm” (STEP S10: NO), the control unit 152 starts the image formation job without moving the loading plate 101 which is stopped at a position at which the attracting distance corresponds to “5 mm (first distance)” (STEP S7).

Table 1 illustrates the “attracting distance table data” described above.

TABLE 1

| | | GRAMMAGE | | | |
|---|---|---|---|---|---|
| | TYPE OF | SMALL —————————————→ LARGE | | | |
| | PAPER | ~105 gsm | 106~300 gsm | 301~400 gsm | 401 gsm~ |
| ATTRACTING | DOUBLE-SIDED | 5 mm (X1) | 5 mm (X1) | 5 mm (X1) | 5 mm (X1) |
| DISTANCE | COATED PAPER | | | | |
| | SINGLE-SIDED | 3 mm (X2) | 3 mm (X2) | 3 mm (X2) | 3 mm (X2) |
| | COATED PAPER | | | | |
| | PLAIN PAPER | 5 mm (X1) | 5 mm (X1) | 5 mm (X1) | 3 mm (X2) |

As illustrated in Table 1, the “attracting distance” for the double-sided coated paper is set to “5 mm” (first distance), and the “attracting distance” for the single-sided coated paper is set to “3 mm” (second distance). That is, the sheet position (paper surface height) of the uppermost sheet P stacked on the loading plate 101 differs in the cases where the sheet P stacked on the loading plate 101 is the “single-sided coated paper” or the “double-sided coated paper”.

To be noted, the plain paper (uncoated paper) has physical properties that are intermediate between the single-sided coated paper and the double-sided coated paper. Therefore, in terms of suppressing the separation failure and the prevention of the attracting failure, neither the attracting distance of “5 mm” nor “3 mm” is deemed advantageous. However, generally, the thickest sheets P with a large grammage (hereinafter, conveniently referred to as thick paper) tend to cause the attracting failure, and thin sheets P with a small grammage (hereinafter, conveniently referred to as thin paper) tend to cause the separation failure. That is, because the thick paper is heavy, it is difficult to float and tends to cause the attracting failure; on the other hand, because the thin paper is light, a force resisting cohesive attraction between sheets is reduced, and, accordingly, the thin paper tends to cause the separation failure. Therefore, it is desirable to elevate the sheet position (paper surface height) for the sheets P with the large grammage, and to lower the sheet position (paper surface height) for the sheets P with the small grammage. Accordingly, in this embodiment, with respect to the attracting distance for the plain paper, it is set to “5 mm” in a case where the grammage is equal to or less than “400 gsm”, and it is set to “3 mm” in a case where the grammage is equal to or more than “401 gsm”.

To be noted, in the case where the sheet P is the “double-sided coated paper” or the “plain paper (with a grammage of equal to or less than 400 gsm)”, upon feeding the sheet P during the image formation job, control to elevate and stop the loading plate 101 at the sheet position at which the attracting distance corresponds to the “first distance (X1)” is repeated. On the other hand, in a case where the sheet P is the “single-sided coated paper” or the “plain paper (with a grammage of equal to or more than 401 gsm)”, upon feeding the sheet P during the image formation job, control to elevate and stop the loading plate 101 at the sheet position at which the attracting distance corresponds to the “second distance (X2)” is repeated. That is, even during the image formation job, the sorting air is always blown with respect to the uppermost sheet P at the sheet position at which the attracting distance corresponds to the “first distance (X1)” (or at the sheet position at which the attracting distance corresponds to the “second distance (X2))”.

As described above, in this embodiment, in the case where the sheet P stacked on the loading plate 101 is the “double-sided coated paper”, the sheet P is fed from the loading plate 101 which is stopped (i.e., located) at the position at which the attracting distance corresponds to the “first distance”. On the other hand, in the case where the sheet P stacked on the loading plate 101 is the “single-sided coated paper”, the sheet P is fed from the loading plate 101 which is stopped at the position at which the attracting distance corresponds to the “second distance”, which is shorter than the “first distance”. That is, in the case of the double-sided coated paper, the feeding of the sheet P is performed by lowering the sheet position (paper surface height) of the uppermost sheet P stacked on the loading plate 101, and, in the case of the single-sided coated paper, the feeding of the sheet P is performed by elevating the sheet position (paper surface height) to a level higher than the case of the double-sided coated paper. Thereby, it is possible to achieve both the suppression of the separation failure, which may occur in the case of the double-sided coated paper, and the prevention of the attracting failure, which may occur in the case of the single-sided coated paper.

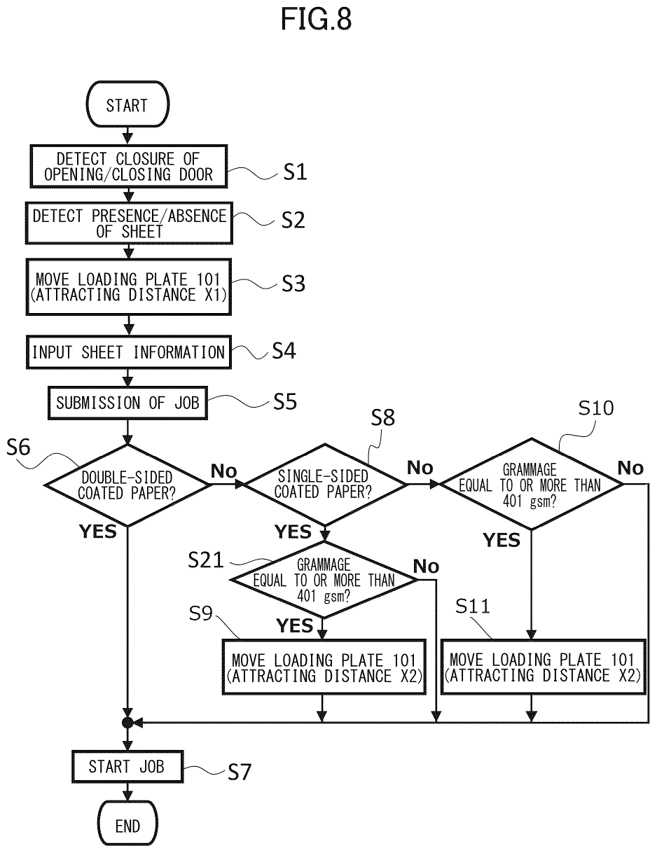

Incidentally, in the “lifting control process” described above, in the case of the “single-sided coated paper”, the loading plate 101 is elevated and stopped at a position at which the attracting distance corresponds to “3 mm (second distance” regardless of the thickness (grammage) of the sheet (refer to STEPS S8 and S9 in FIG. 7). However, in a case where the “single-sided coated paper” is the thin paper, when the uppermost sheet P is approached to the attracting belt 107, since the thin paper is light, the separation failure becomes likely to occur. On the other hand, in the case where the “single-sided coated paper” is the thin paper, if the rigidity is sufficiently low, curling to an extent that causes the attracting failure is unlikely to occur; therefore, depending on a model of the sheet feeding deck 100, it may be appropriate to allocate a priority to countermeasures against the separation failure. For example, in a first sheet feeding deck with a large flow rate of the sorting air, compared to a second sheet feeding deck with a lower flow rate of air, when the uppermost sheet P is approached to the attracting belt 107, the separation failure is likely to occur in a case of the thin paper. Therefore, in the case of the first sheet feeding deck, it may be to allocate a priority to countermeasures against the separation failure. Accordingly, “attracting distance table data” illustrated in Table 2 and a “lifting control process (program)” illustrated in FIG. 8 are pre-stored in the memory 153 of the first sheet feeding deck.

Table 2 illustrates the “attracting distance table data” for thin single-sided coated paper with priority given to countermeasures against the separation failure. As illustrated in Table 2, in a case where the grammage of the single-sided coated paper is equal to or less than “400 gsm”, similar to the double-sided coated paper and the plain paper, the attracting distance is set to “5 mm”.

TABLE 2

| | | GRAMMAGE | | | |
|---|---|---|---|---|---|
| | TYPE OF | SMALL —————————————→ LARGE | | | |
| | PAPER | ~105 gsm | 106~300 gsm | 301~400 gsm | 401 gsm~ |
| ATTRACTING | DOUBLE-SIDED | 5 mm (X1) | 5 mm (X1) | 5 mm (X1) | 5 mm (X1) |
| DISTANCE | COATED PAPER | | | | |
| | SINGLE-SIDED | 5 mm (X1) | 5 mm (X1) | 5 mm (X1) | 3 mm (X2) |
| | COATED PAPER | | | | |
| | PLAIN PAPER | 5 mm (X1) | 5 mm (X1) | 5 mm (X1) | 3 mm (X2) |

In FIG. 8, another embodiment of the “lifting control process” using the “attracting distance table data” of Table 2 is illustrated. In comparison with the “lifting control process” illustrated in FIG. 7, in the “lifting control process” illustrated in FIG. 8, a process of STEP S21 is added. Therefore, herein, by putting the same step numbers to processes which are identical to those of the “lifting control process” illustrated in FIG. 7, the description will be simplified or omitted.

As illustrated in FIG. 8, in a case where it is detected that the opening/closing door has been closed (STEP S1), the control unit 152 detects whether or not the sheet P is stacked on the loading plate 101 of the sheet storage portion 100a (STEP S2). In a case where the sheet storage portion 100a with the sheet P stacked on the loading plate 101 has been returned to the apparatus body 80 (STEP S2), the control unit 152 controls the motor 31 such that the loading plate 101 is elevated from the lower limit position and stopped by the lifting mechanism 150 (STEP S3). Thereafter, the control unit 152 receives the input of the information related to the sheet P from the operation unit 151 (STEP S4). Upon receiving the start of the image formation job (STEP S5), based on the input information related to the sheet P, the control unit 152 determines whether or not the sheet P stacked on the loading plate 101 is the “double-sided coated paper” (STEP S6). In the case where it is the “double-sided coated paper” (STEP S6: YES), the control unit 152 starts the image formation job without moving the loading plate 101 (STEP S7).

In a case where the sheet P stacked on the loading plate 101 is not the “double-sided coated paper” (STEP S6: NO) but the “single-sided coated paper” (STEP S8: YES), the control unit 152 determines whether or not the grammage of the sheet P is equal to or more than “401 gsm” (equal to or more than a predetermined value) (STEP S21). In a case where the grammage of the sheet P is equal to or more than “401 gsm” (STEP S21: YES), before starting the image formation job, the control unit 152 elevates and stops the loading plate 101 at a position at which the attracting distance corresponds to “3 mm (second distance)” (refer to Table 1) (STEP S9). Thereafter, the control unit 152 starts the image formation job (STEP S7). On the other hand, in a case where the grammage of the sheet P is less than “401 gsm” (STEP S21: NO), the control unit 152 starts the image formation job while stopping the loading plate 101 at a position at which the attracting distance corresponds to “5 mm (first distance)” (STEP S7). As described above, in the first sheet feeding deck with the large flow rate of the sorting air, while achieving both the suppression of the separation failure, which may occur in the case of the double-sided coated paper, and the prevention of the attracting failure, which may occur in the case of the single-sided coated paper, it is possible to reduce the likelihood of the separation failure, which may occur when processing the thin single-sided coated paper.

In a case where the sheet P stacked on the loading plate 101 is not the “single-sided coated paper”, that is, is the “plain paper (uncoated paper)” (STEP S8: NO), the control unit 152 determines whether or not the grammage of the sheet P is equal to or more than “401 gsm” (STEP S10). In a case where the grammage of the sheet P is equal to or more than “401 gsm” (STEP S10: YES), before starting the image formation job, the control unit 152 elevates and stops the loading plate 101 at a position at which the attracting distance corresponds to “3 mm (second distance)” (refer to Table 1) (STEP S11). Thereafter, the control unit 152 starts the image formation job (STEP S7). On the other hand, in a case where the grammage of the sheet P is less than “401 gsm” (STEP S10: NO), the control unit 152 starts the image formation job without moving the loading plate 101 that is stopped at a position at which the attracting distance corresponds to “5 mm (first distance)” (STEP S7).

According to this disclosure, it is possible to suppress the occurrence of the separation failure and the attracting failure of the sheet when feeding the sheet, whose surface is coated, from the sheet supporting portion.

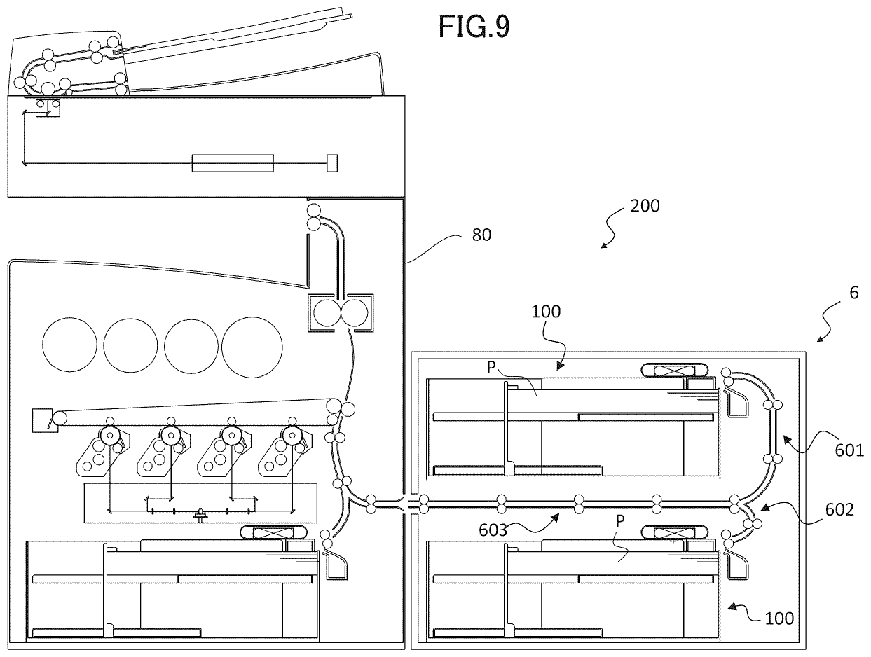

To be noted, the sheet feeding deck 100 is not limited to being disposed within the apparatus body 80 (refer to FIG. 1), but may be disposed external to the apparatus body 80. For example, as illustrated in FIG. 9, an external sheet feeding apparatus 6 is connected in a manner capable of delivering the sheet P to the apparatus body 80. An image forming apparatus 200 connected to the external sheet feeding apparatus 6 is illustrated in FIG. 9. The image forming apparatus 200 has the same configuration as the image forming apparatus 1 described above (refer to FIG. 1), except that the external sheet feeding apparatus 6 is connected to the apparatus body 80.

As illustrated in FIG. 9, the external sheet feeding apparatus 6 includes two sheet feeding decks 100, and can feed the sheet P from each sheet feeding deck 100 to the apparatus body 80. The sheets P fed from the two sheet feeding decks 100 are conveyed via respective conveyance paths 601 and 602, then pass through a common conveyance path 603, and are supplied to the apparatus body 80. By utilizing the external sheet feeding apparatus 6, not only does the number of sheets that can be stacked increase, but also it is possible to load different types of the sheets P together for each sheet feeding deck 100; therefore, it is possible to produce various printed products.

To be noted, in the embodiments described above, the image forming apparatus of the intermediate transfer system is described as an example, in which, after the toner images of each color have been primarily transferred from the photosensitive drums 11Y to 11K of each color onto the intermediate transfer belt 31, the toner images of each color is transferred onto the sheet P; however, it is not limited to this. For example, an image forming apparatus may adopt a direct transfer system in which, with respect to the sheet P conveyed by a conveyance belt having a nip portion formed with a photosensitive drum, a toner image on the photosensitive drum is directly transferred onto the sheet P conveyed by the conveyance belt by applying voltage to a transfer roller disposed opposite the photosensitive drum across the conveyance belt. In addition, it is not limited to image forming apparatuses of the electrophotographic system, and, this disclosure may be applicable to, for example, inkjet recording apparatuses that form images with ink.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-013571, filed Jan. 30, 2025 which is hereby incorporated by reference herein in its entirety.

What is claimed is:

1. A sheet feeding apparatus comprising:
a sheet supporting portion configured to support a sheet;
a lifting unit configured to vertically move the sheet supporting portion;
an air blowing unit configured to float the sheet by blowing air to the sheet supported on the sheet supporting portion;
a sheet feeding belt configured to convey the sheet by attracting the sheet which is floated;
a detection unit configured to detect a position of an uppermost sheet supported on the sheet supporting portion; and
a control unit configured to control the lifting unit,
wherein
in a case where a sheet supported on the sheet supporting portion is a double-sided processed sheet with both surfaces coated with a coating agent, the control unit is configured to stop the sheet supporting portion at a position at which a distance between the position of the uppermost sheet detected by the detection unit and the sheet feeding belt corresponds to a first distance, and
in a case where a sheet supported on the sheet supporting portion is a single-sided processed sheet with a first surface of the sheet coated with the coating agent and a second surface opposite to the first surface not coated with the coating agent, the control unit is configured to stop the sheet supporting portion at a position at which the distance between the position of the uppermost sheet detected by the detection unit and the sheet feeding belt corresponds to a second distance that is shorter than the first distance.

2. The sheet feeding apparatus according to claim 1, further comprising an information input unit to which information that indicates whether the sheet supported on the sheet supporting portion is the double-sided processed sheet or the single-sided processed sheet is input.

3. The sheet feeding apparatus according to claim 1,
wherein
in a case where a grammage of the single-sided processed sheet is equal to or more than a predetermined value, the control unit is configured to stop the sheet supporting portion at a position at which the distance between the position of the uppermost sheet and the sheet feeding belt corresponds to the second distance, and
in a case where the grammage of the single-sided processed sheet is less than the predetermined value, the control unit is configured to stop the sheet supporting portion at a position at which the distance between the position of the uppermost sheet and the sheet feeding belt corresponds to the first distance.

4. The sheet feeding apparatus according to claim 1,
wherein
regardless of whether the sheet supported on the sheet supporting portion is the double-sided processed sheet or the single-sided processed sheet, the control unit is configured to stop the sheet supporting portion at a position at which the distance between the position of the uppermost sheet and the sheet feeding belt corresponds to the first distance,
in a case where the sheet supported on the sheet supporting portion is the double-sided processed sheet, the control unit is configured to keep the sheet supporting portion stopped, and
in a case where the sheet supported on the sheet supporting portion is the single-sided processed sheet, the control unit is configured to move and stop the sheet supporting portion at a position at which the distance between the position of the uppermost sheet and the sheet feeding belt corresponds to the second distance.

5. The sheet feeding apparatus according to claim 4, wherein in a case where the sheet supported on the sheet supporting portion is neither the double-sided processed sheet nor the single-sided processed sheet, based on a grammage of the sheet, the control unit is configured to either keep the sheet supporting portion stopped, or to move and stop the sheet supporting portion at a position at which the distance between the position of the uppermost sheet and the sheet feeding belt corresponds to the second distance.

6. The sheet feeding apparatus according to claim 1, wherein the air blowing unit is configured to blow air at least to a side edge of the sheet from a width direction that intersects a feeding direction of the sheet by the sheet feeding belt.

7. The sheet feeding apparatus according to claim 1,
wherein the detection unit includes:
a swing member configured to swing to come into contact with the uppermost sheet supported on the sheet supporting portion in response to a raising of the sheet supporting portion;
a first detected portion configured to be displaced in response to a swing of the swing member;
a second detected portion configured to be displaced independently of the first detected portion in response to the swing of the swing member;
a first sensor configured to detect the first detected portion that is displaced in response to the swing of the swing member; and
a second sensor configured to detect the second detected portion that is displaced in response to the swing of the swing member, and
wherein the detection unit is configured to detect the position of the uppermost sheet based on whether the detection unit is in a first detection state in which the first sensor detects the first detected portion and the second sensor detects the second detected portion, a second detection state in which the first sensor detects the first detected portion and the second sensor does not detect the second detected portion or the first sensor does not detect the first detected portion and the second sensor detects the second detected portion, or a non-detection state in which the first sensor does not detect the first detected portion and the second sensor does not detect the second detected portion.

8. The sheet feeding apparatus according to claim 7,
wherein
in a case of transitioning from the first detection state to the second detection state, the detection unit is configured to detect that the position of the uppermost sheet is located at the first distance from the sheet feeding belt, and
in a case of transitioning from the second detection state to the non-detection state, the detection unit is configured to detect that the position of the uppermost sheet is located at the second distance from the sheet feeding belt.

9. The sheet feeding apparatus according to claim 7,
wherein with respect to a feeding direction of the sheet, the sheet feeding belt is arranged further downstream than a center of the sheet supporting portion such that an upstream edge of the sheet feeding belt overlaps the sheet supporting portion when viewed from above, and
wherein with respect to the feeding direction, the swing member is configured to come into contact with the uppermost sheet supported on the sheet supporting portion at a location further upstream than the upstream edge of the sheet feeding belt.

10. An image forming apparatus comprising:
the sheet feeding apparatus according to claim 1; and
an image forming unit configured to form an image on the sheet that is fed from the sheet feeding apparatus.

11. A sheet feeding apparatus comprising:
a sheet supporting portion configured to support a sheet;
a lifting unit configured to vertically move the sheet supporting portion;
an air blowing unit configured to float the sheet by blowing air to the sheet supported on the sheet supporting portion;
a detection unit configured to detect a position of an uppermost sheet supported on the sheet supporting portion; and
a control unit configured to control the lifting unit,
wherein in a case where the sheet supported on the sheet supporting portion is a single-sided processed sheet with one surface coated with a coating agent, the control unit is configured to stop the sheet supporting portion at a higher position than a position at which the sheet supporting portion is stopped in a case where the sheet supported on the sheet supporting portion is a double-sided processed sheet with both surfaces coated with a coating agent.
